(19) United States
(12) Patent Application Publication
(10) Pub. No.: US 2006/0220459 A1
(43) Pub. Date: Oct. 5, 2006

(54) Sensing circuits

(75) Inventor: Nishanth Kulasekeram, Cambridge (GB)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 11/352,253

(22) Filed: Feb. 13, 2006

(30) Foreign Application Priority Data
Mar. 31, 2005 (GB) 0506597.4

(51) Int. Cl. H02J 1/00

(52) U.S. Cl. 307/11

(57) ABSTRACT

A current sensing circuit comprising a current amplification stage for amplifying a sensed current input, and a comparator having as a first input the amplified sensed current input. The amplification stage comprises a first transistor connected between a first rail and a second rail, the sensed current being input to a source of the first transistor, the amplified sensed current being output from the drain of the first transistor, and a gate of the first transistor being biased. The circuit is capable of sensing an analogue signal of 100 μA or less and outputting a rail-to-rail digital signal.

The present invention relates to sensing circuits. Preferably, the sensing circuits are suitable for sensing currents considerably smaller than is conventional.

Sensing circuits form an important class of digital design because of their use in retime circuitry for sensing data and reclocking; deskew circuitry for delaying a clock signal for example in a phase locked loop (PLL); and receive circuitry. This class of circuitry is also widely used in memory circuits.

A basic known sensing circuit contains a sensing front-end followed by a latch stage. Its function is to detect the charge stored in a selected memory element within a matrix of memory cells and thus to determine whether the selected memory element stores a ‘0’ or a ‘1’. Prior work on sensing circuits has included efforts at utilising sensing circuit front-ends to improve sensitivity and speed of conventional flip-flops.

Most existing sensing circuits are based on voltage sensing of a matrix of storage capacitors. The voltage level across the storage capacitor corresponds to the logic-state (‘0’ or ‘1’). In the simplest case, this voltage is compared to an intermediate value and the difference is amplified.

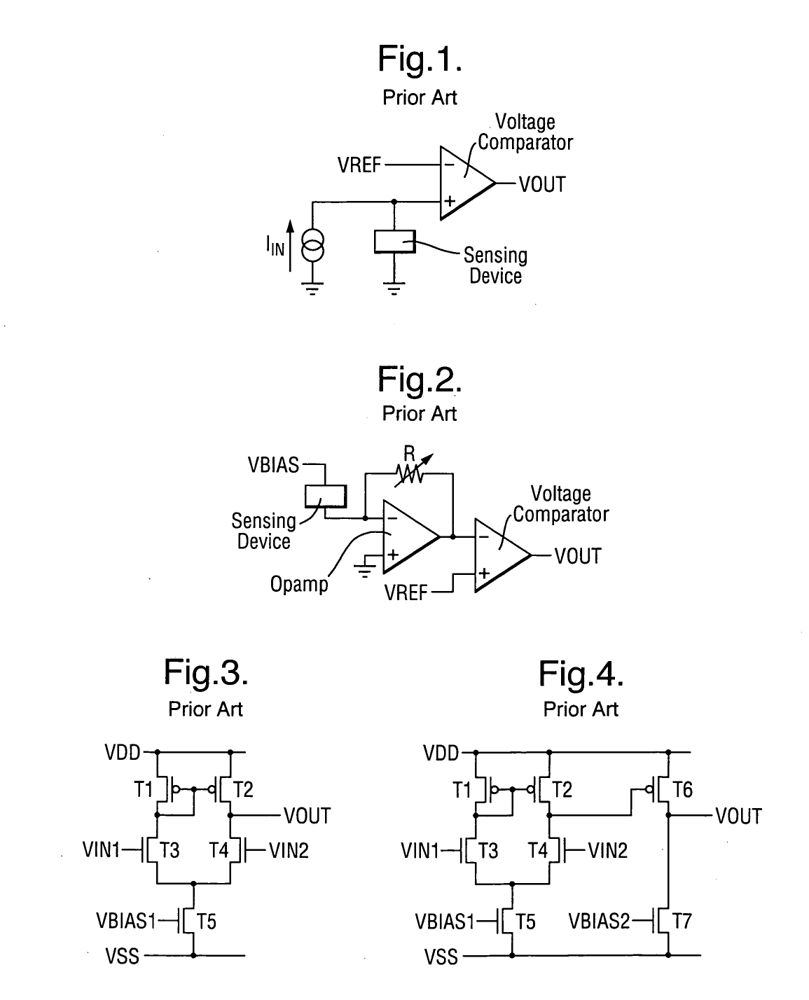

FIG. 1 shows a conventional sensing circuit comprising a voltage comparator having two inputs. The first is connected to a reference voltage VREF and the second to a current source. A sensing device is connected in parallel with the current source. Changes in the characteristics of the sensing device affect the voltage applied as the second input to the voltage comparator. Thus, if the sensing device is a memory cell, the second input to the comparator changes depending on whether charge corresponding to a ‘0’ or a ‘1’ is stored in the memory cell. The input is compared with the reference voltage and a signal representing the difference between the two inputs is output.

In FIG. 2, the sensing device is connected in series between a voltage bias VBIAS and one input of an operational amplifier Opamp connected with negative feedback. The voltage input to the operational amplifier changes as the characteristics of the sensing device change. The other input of the operational amplifier is earthed. In this way, the voltage representative of the property sensed by the sensing device is amplified, before being input to a voltage comparator in a similar way as FIG. 1. It should be noted, however, that in FIG. 1 VREF is input to the negative terminal of the voltage comparator, whereas in FIG. 2 VREF is input to the positive terminal of the voltage comparator.

FIG. 3 shows a conventional voltage comparator circuit comprising a transistor current mirror. The current mirror active load is a way to accomplish high gain for a single stage differential amplifier. The transistors T3 and T4 make up a differential amplifier. The differential inputs of, for example, a sensed voltage VIN1 and a reference voltage VIN2 are connected to respective gates of transistors T3 and T4. Transistors T1 and T2 make up a current mirror, since both transistors T3 and T4 are connected between the rails VDD and VSS and they share the same gate input. Notably, transistor T1 is also diode-connected. The current mirror acts as a collector load and provides a high effective collector load resistance, increasing the gain. Such a device can produce a gain of 5000 or more with no load. However, this gain drops with loading. The output voltage VOUT is taken from the branch of the current mirror that does not include the diode-connected transistor T1. VOUT can be determined as VOUT=A1(VIN1−VIN2), where A1 is the amplification factor. This can be controlled in part by changing the bias voltage VBIAS1 applied to the gate of the common bias transistor T5 that is connected to the tail of the differential pair of transistors T3, T4.

FIG. 4 shows a conventional operational amplifier circuit. Essentially the operational amplifier circuit includes-the voltage comparator shown in FIG. 3, as well as a further amplification stage. This output amplification stage comprises a common drain-connected transistor T6 and a transistor T7 having a further bias voltage VBIAS2 applied to its gate.

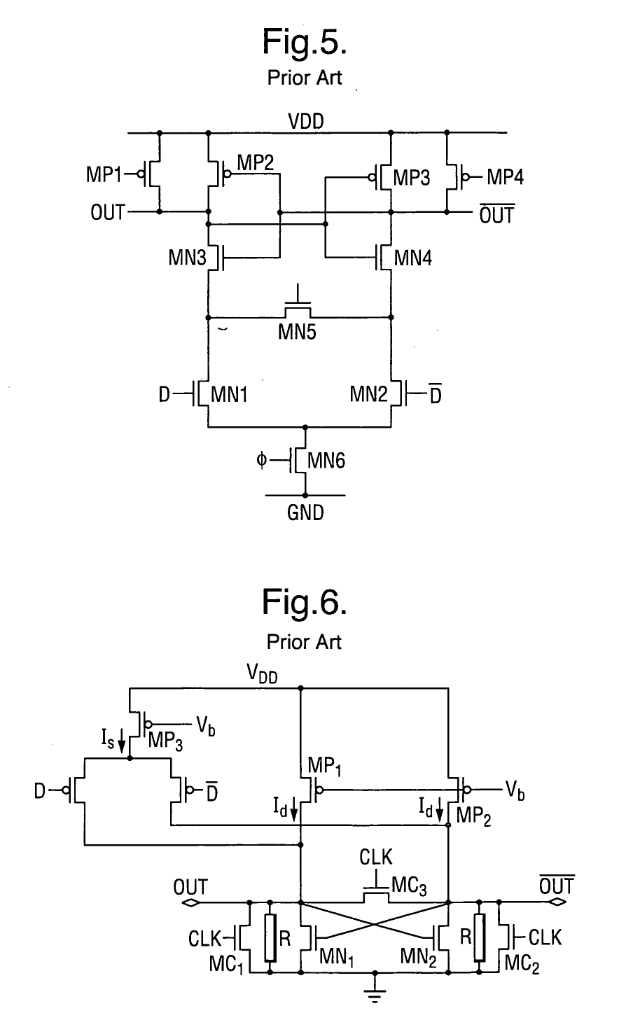

A conventional voltage sense-amplifier (CVSA) schematic is shown in FIG. 5. Specifically, FIG. 5 shows a sense amplifier, which has inputs D and Dbar (for example from a memory cell) and outputs from bit lines OUT and OUTbar. The flip-flop type arrangement in FIG. 5 ensures the outputs OUT and OUTbar are complementary.

The operation of the sense amplifier consists of a precharge/discharge and evaluation phase. To reduce DC power consumption, the sense amplifier has a clocked transistor in the evaluation chain. Specifically, the use of a clocked signal Φ to control switching of the bottom transistor allows the path to ground to be cut off for power saving.

The sense amplifier is triggered on the leading edge of the transistor clock. If D is high, the precharged node OUT is discharged through the path MN3, MN1 and MN6, turning MN4 off and MP3 on. If Dbar is high, the precharged node OUTbar is discharged through the path MN4, MN2 and MN6, turning MN3 off and MP2 on.

FIG. 6 shows a current steering logic sense amplifier (CSLSA), which is also known. When a clock signal CLK is high, both OUT and OUTbar are precharged to ground. At the falling edge of the clock signal CLK, if node D is low, a current Id+Is flows through transistor MC1 and only current Id flows through MC2. As a result of the disparity in current, OUT changes from 0 to Id, while OUTbar remains at ground.

Conventional sensing circuits have the bit lines OUT and OUTbar feeding directly as the inputs VIN1 and VIN2 into the respective gates of the transistors in the voltage comparator. This is effectively a high impedance input. Thus, a problem experienced by conventional sensing circuits is their comparatively high power and voltage requirements. In particular, in order to read the memory cell using the amplifier shown in FIG. 5, the values of D and Dbar from the memory cell must be sufficiently high to switch on the respective transistors to which they are input.

It is desirable to produce memory circuits that use as little power, and consequently have as low current and voltage requirements, as possible. However, the gate inputs must be sufficiently highly powered switch on, for example, transistors T3 and T4 respectively shown in FIGS. 3 and 4. This also affects the speed of operation of the circuits.

In addition, sensing devices such as those shown in FIGS. 1 and 2 are commonly used for applications such as DNA and finger print sensing where only extremely small changes in currents or voltages must be detected. It is also desirable to provide other types of memory, such as passive matrix FeRAM and optical memories, with lower power requirements and high speed.

Conventional techniques as shown in FIG. 2 attempt to overcome this problem by amplifying the sensed voltage signal using an operational amplifier before input to the voltage comparator together with the reference voltage VREF. However, as is evident from FIG. 4, the problem of a high impedance input is not overcome.

The present invention is intended to address the problem of accurately sensing current of the order of a few 10s and 100s of micro amps.

Another objective of this invention is to address the problem of reducing the relative power dissipation of a conventional voltage mode sense-amplifier (CVSA), or a current steering logic sense-amplifier (CSLSA).

According to the present invention, there is provided a current sensing circuit comprising a current amplification stage for amplifying a sensed current input, and a comparator having as a first input the amplified sensed current input.

Preferably, the amplification stage comprises a common-gate connected first transistor and more preferably the amplification stage comprises a first transistor connected between a first rail and a second rail, the sensed current being input to a source of the first transistor, the amplified sensed current being output from the drain of the first transistor, and a gate of the first transistor being biased. Advantageously, the first transistor is connected between first and second loads, which may be resistors or, in another embodiment, at least one of the first and second loads is an active load. It is preferred that the active load is a biased transistor a gate of which is biased by bias circuitry, said biased transistor being connected between the first transistor and a rail.

Advantageously, a second input of the comparator is amplified by the amplification stage.

Preferably, the comparator is a differential voltage comparator. This differential voltage comparator may comprise a comparator current mirror and a comparator differential amplifier, the inputs to the comparator differential amplifier being applied to gates of respective transistors of the comparator differential amplifier.

Advantageously, each branch of the comparator current mirror comprises a comparator current mirror transistor, a gate of each of said comparator current mirror transistors being biased by bias circuitry.

The differential voltage comparator may have a single output if preferred. Alternatively, the differential voltage comparator may comprise a comparator current mirror and have an output from each branch of said comparator current mirror. In that case, the respective outputs of the differential voltage comparator are preferably input to respective branches of a second current mirror.

Alternatively, an output of one branch of the second current mirror is output to a second amplification stage. Preferably, an output of the second amplification stage is connected to a third current mirror. It is preferred that the third current mirror comprises at least two branches, each branch having a pair of transistors, a gate of a first one of each of said pair of transistors being connected to a gate of a transistor in the second amplification stage, and a gate of a second one of each of said pair of transistors being biased by bias circuitry. An output of each branch of the third current mirror may be connected to a push-pull circuit.

Alternatively, an output of each branch of the comparator current mirror is connected to a push-pull circuit.

In a further alternative, an output of each branch of the second current mirror is connected to a push-pull circuit.

Where there is a single output, this may be connected to an amplifier.

In a preferred embodiment, the circuit is capable of sensing an analogue signal of 100 μA or less and outputting a rail-to-rail digital signal.

The present invention will now be described by way of example only with reference to the following drawings, in which

FIG. 1 shows one embodiment of a conventional sensing circuit;

FIG. 2 shows another embodiment of a conventional sensing circuit;

FIG. 3 shows a conventional voltage comparator circuit;

FIG. 4 shows a conventional operational amplifier circuit;

FIG. 5 shows a conventional voltage sense amplifier (CVSA);

FIG. 6 shows a conventional current steering logic sense amplifier (CSLSA);

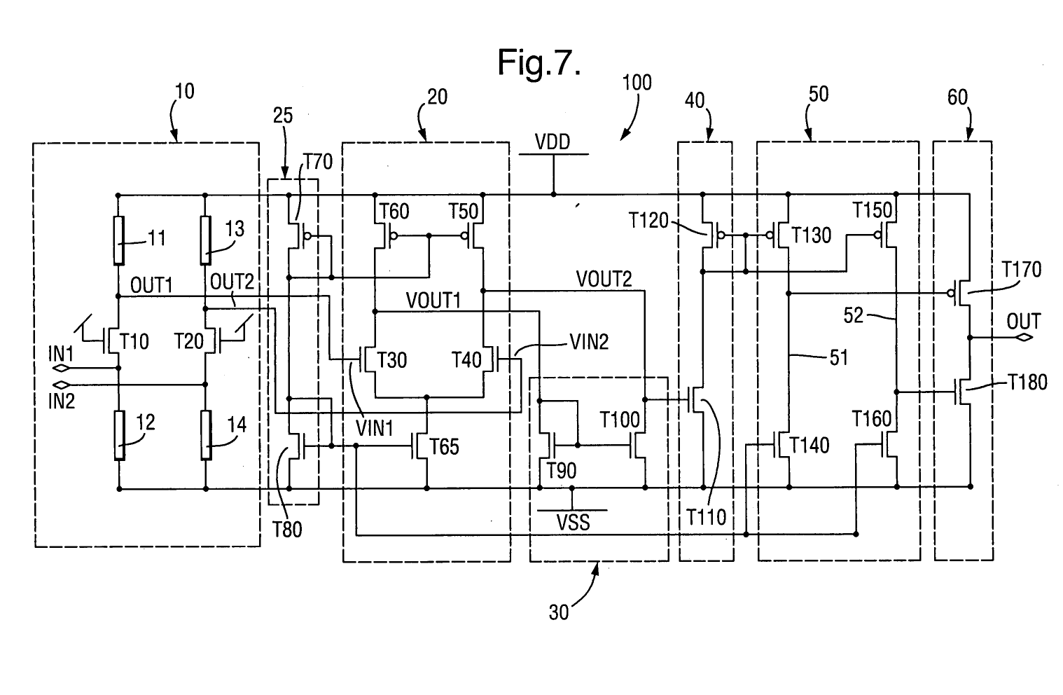

FIG. 7 is a schematic illustration of a sensing circuit of one embodiment of the present invention;

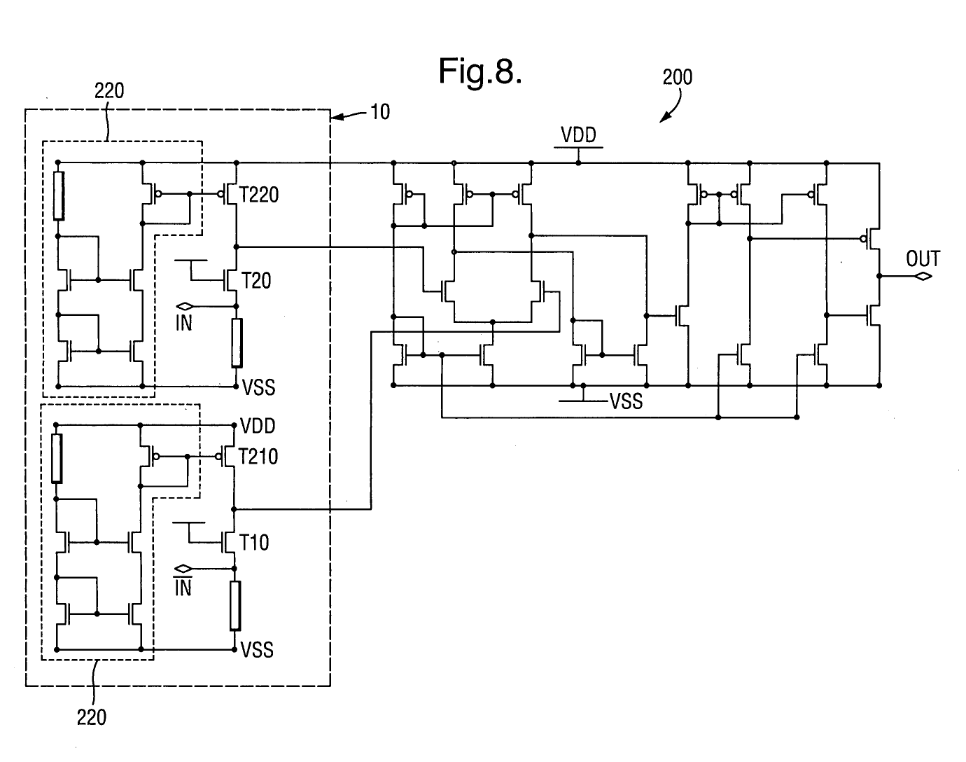

FIG. 8 is a schematic illustration of a sensing circuit of another embodiment of the present invention; and

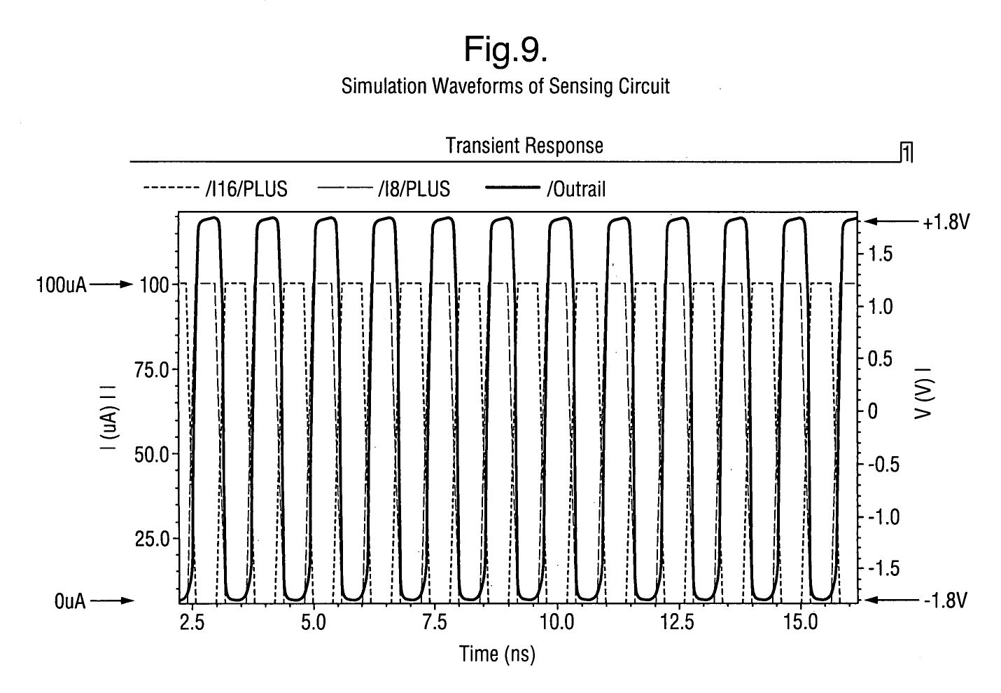

FIG. 9 shows a simulation of waveforms of the circuits shown in FIGS. 7 and 8.

An embodiment of the present invention is shown in FIG. 7. The circuit 100 shown in FIG. 7 comprises a low impedance front end 10, a differential voltage comparator 20, a first current mirror 30, an amplification stage 40, a second current mirror 50 and a push-pull circuit 60.

The low impedance front end 10 comprises a differential input common gate stage, having as inputs in1 and in2 the respective currents that are to be sensed. For example, currents in1 and in2 could be fed from a memory cell. Alternatively, in1 could be fed from a sensing device such as those shown in FIGS. 1 and 2. Input in2 could be fed from a reference current source, which could be another sensing device that is not exposed to the conditions to be tested.

The input common gate stage for in1 runs between first and second rails VDD, VSS and comprises a transistor T10, which has a bias voltage applied to its gate and is connected in series between two resistor loads 11, 12. The current in1 is connected to the source of the transistor T10 and the output out1 of the input common gate stage is connected to the drain of the transistor T10. Since the gate of transistor T10 is already biased, there is no need for the sensed current to be at a sufficient voltage to overcome the threshold voltage of the transistor. Thus, the input in1 is a low impedance input that can be suitably amplified. The degree of amplification can be controlled by selecting the resistances of resistors 11, 12 as desired.

Similarly, the input common gate stage for in2 runs between first and second rails VDD, VSS and comprises a transistor T20, which has a bias voltage applied to its gate and is connected in series between two resistor loads 13, 14. Preferably, the transistor T20 and the two resistor loads 13, 14 are matched with the transistor T10 and the two resistor loads 11, 12. The current in2 is connected to the source of the transistor T20 and the output out2 is connected to the drain of the transistor T20. Thus, the input in2 is also a low impedance input.

Both the input common gate stages operate under the same conditions, except that their current inputs in1, in2 vary depending on a change in the parameters related to the specific event the sensor circuit is designed to sense.

Since each current input is fed directly onto the source of a transistor which is biased by having a biased voltage applied to its gate, the inputs are low impedance inputs. In particular, there is no need for an input signal to overcome the threshold voltage of a transistor. This directly influences the operational frequency, and hence the bandwidth and sensitivity, of the sense amplifier. In addition, the input stage noise contribution is relatively low in this common-gate configuration compared with conventional sense circuit input configurations.

Thus, the low impedance front end 10 acts to sense the differential currents, to amplify the current difference between the two current inputs and to interface with the subsequent differential voltage amplification stage. In particular, it provides the necessary first stage gain.

The differential outputs out1 and out2 of the front end 10 form inputs VIN1 and VIN2 to the differential voltage comparator 20. The differential voltage comparator 20 is similar to the prior art differential voltage comparator shown in FIG. 3. However, the transistor T60 is not diode connected. Rather, the circuit 100 includes bias circuitry 25 provided to bias the gates of the transistors T50, T60 having a current mirrored from transistor T70. The bias circuitry 25 is also used to bias common transistor T65 of the differential voltage comparator 20. This arrangement allows a differential output VOUT1 and VOUT2 from the differential voltage comparator 20.

VOUT1 from the differential voltage comparator 20 is fed into a first branch of the first current mirror 30 and VOUT2 is fed into a second branch of the first current mirror 30. A single transistor T90, T100 is provided in each branch. VOUT1 is used as the common input to the gates of both transistors T90, T100 and a single output is taken from the second branch, connected to VOUT2.

The single output from the first current mirror 30 forms the input of the amplification stage 40. The amplification stage is a common source amplifier having its input connected to the gate of transistor T110 and its output connected to the drain of transistor T110. Diode-connected transistor T120 acts as a load.

As well as acting to diode connect transistor T120, the output of the amplification stage 40 acts as the gate input for both transistors T130 and T150 in the respective branches 51, 52 of the second current mirror 50. It is noted that the since transistor T120 shares the same gate input as transistors T130 and T150, the respective branches 51, 52 of the second current mirror 50 are in fact mirrored in the amplification stage 40. The second transistors T140, T160 of the respective branches 51, 52 of the second current mirror 50 are biased using bias circuitry 25.

The respective outputs of the branches 51, 52 of the second current mirror 50 are input to the gates of the P-type T150 and N-type T160 transistors of the push-pull stage 60, which is connected between the two rails VSS, VDD. Accordingly, the output of the circuit is a single output at VDD or VSS.

In short, FIG. 7 shows a differential input detection circuit with a common-gate low impedance front-end structure. This circuit configuration provides the necessary first stage gain. This stage is followed by feeding the signal into a source coupled differential input stage, which provides the necessary second stage gain. The signal from the differential output stage is fed thorough a current mirror followed by a common source amplifier. This signal is further mirrored and connected to the push-pull pair to provide the rail to rail voltage swing at the output stage.

The present invention therefore provides a sensing circuit with a low impedance front end. The front end may be an analogue front end capable of sensing current of the order of a few 10s and 100s of micro amps. Preferably, each input is passed through a common-gate low impedance front end and the circuit gives a rail-to-rail single-ended digital output swing. Preferably, the circuit is capable of driving a latch or of preceding respective stages of digital circuitry. Thus, the circuit is preferably capable of detecting a small differential signal and converting that into a rail-to-rail large digital signal at the single-ended output.

FIG. 9 shows a simulation of waveforms of the sensing circuits shown in FIG. 7 and FIG. 8 (described below). In particular, FIG. 9 shows the transient response of the circuits shown in FIGS. 7 and 8 with inputs “/I16/PLUS” and “/I8/PLUS” shown against the left hand axis and the corresponding output “/outrail” shown against the right hand axis, with time shown along the horizontal axis. As illustrated by FIG. 9, varying differential inputs of 100 μA provide a rail-to-rail output of −1.8V to +1.8V, with a switching time from a ‘1’ to a ‘0’ and back to a ‘1’ in as little as 1.5 ns. In particular, as input “/I16/PLUS” goes low and input “/I8/PLUS” goes high, the output goes high. Similarly, as input “/I16/PLUS” goes high and input “/I8/PLUS” goes low, the output goes low.

In addition, the present invention allows a reduction in power dissipation relative to a conventional voltage mode sense-amplifier (CVSA) such as that shown in FIG. 5, or a current steering logic sense-amplifier (CSLSA) such as that shown in FIG. 6. The circuit topology in the above-described embodiment for the common-gate and differential input structures is intended to provide an improved power saving, achievable through the use of low voltage transistors.

Another embodiment of the present invention is shown in FIG. 8. As can be seen from a comparison of FIGS. 7 and 8, the circuit 200 shown in FIG. 8 includes the same differential voltage comparator 20, bias circuitry 25, first current mirror 30, amplification stage 40, second current mirror 50 and push-pull pair 60 all connected between rails VDD and VSS as the circuit 100 shown in FIG. 7. These will not be described further.

However, the differential current input stage or front end 10 in FIG. 8 differs from that in FIG. 7. Specifically, first resistor 11, 13 in the respective common gate input stages has been replaced by an active load in the form of a transistor T210, T220. Each transistor T210, T220 is biased by respective bias circuitry 210, 220.

Active devices have much less device variation than passive resistors, which exhibit a 10-15% tolerance depending whether they are poly resistors or nwell resistors. Accordingly, in practice the values of resistors 11 and 13 may differ considerably and consequently the amplification provided by the respective common gate amplification stages in the front end the circuit in FIG. 7 may also differ considerably. In view of the small currents that the circuit 100 is intended to sense, this can cause difficulties. Replacing the resistors 11, 13 in FIG. 7 with biased transistors T210, T220 in FIG. 6 considerably alleviates this problem since the characteristics of the biased transistors T210, T220 are much easier to match than the resistances of the resistors 11, 13. Accordingly, the circuit in FIG. 8 is preferred where more accurate detection of smaller currents is desired.

The circuits shown in FIGS. 7 and 8 are effectively a mixed signal solution. In each case, the front end detects small analogue type signals and the circuit converts them into a large digital (rail-to-rail) signal at the output. The circuits as a result can operate off very low supply rails and can offer the option of low power operation in a predominantly digital environment. Moreover, the circuits have an increased speed since they use fast, small transistors and therefore have very high bandwidth. They can operate at clock speeds of approximately 3.5 GHz. Applications include optical transceivers, active and passive matrix FeRAM and other types of memory, finger print sensor circuits, sensor circuits used in medical applications and biometric sensors. Other applications will be apparent to those skilled in the art.

It is preferred that the present invention, including the circuits shown in FIGS. 7 and 8, is implemented using CMOS transistors. In addition, it is preferred that various devices in the circuits are matched. For example, devices in the respective branches of the current mirrors are preferably impedance matched. Thus, transistors T90 and T100 are preferably are preferably matched.

However, implementations other than CMOS, such as TFTs are also possible, although these may require a different topology. In addition, there is no requirement to use the specific circuit implementations shown in the figures. Thus, different arrangements of stages can be used. Moreover, the circuitry in the individual stages need not be used. Other arrangements using different combinations of P-type and N-type transistors or other switching devices are also possible.

Thus, it would be possible to use the low impedance stage 10 shown in FIGS. 7 and 8 as a front end for the differential voltage amplifier shown in FIG. 3. The single output could be amplified as desired and used as an analogue signal. Alternatively, the front end 10 shown in FIGS. 7 and 8 could be replaced with one that comprises a single common gate stage with a single input and a single output. This single output could be amplified or input directly to a differential comparator for comparison with a reference signal generated independently of the front end.

Similarly, it would be possible to diode-connect transistor T60 and use this as the bias voltage for transistor T50 forming the other branch of the comparator current mirror. A single output could be taken from amplification stage 20. Amplification stage 40 or first current mirror 30 could be dispensed with. If desired, it would also be possible to redesign bias circuitry 25, or even do away with it altogether, while making consequent modifications on the remaining portions of the circuitry.

Clearly, many permutations are possible and these fall within the scope of the present invention. Thus, the foregoing description has been given by way of example only and it will be appreciated by a person skilled in the art that modifications can be made without departing from the scope of the present invention.

1. A current sensing circuit comprising a current amplification stage for amplifying a sensed current input, and a differential voltage comparator having as a first input the amplified sensed current input, wherein the differential voltage comparator comprises a comparator current mirror and a comparator differential amplifier, the inputs to the comparator differential amplifier being applied to gates of respective transistors of the comparator differential amplifier.

2. A current sensing circuit according to claim 1, wherein the amplification stage comprises a common-gate connected first transistor.

3. A current sensing circuit according to claim 1, wherein the amplification stage comprises a first transistor connected between a first rail and a second rail, the sensed current being input to a source of the first transistor, the amplified sensed current being output from the drain of the first transistor, and a gate of the first transistor being biased.

4. A current sensing circuit according to claim 2, wherein the first transistor is connected between first and second loads.

5. A current sensing circuit according to claim 4, wherein the first and second loads are resistors.

6. A current sensing circuit according to claim 4, wherein at least one of the first and second loads is an active load.

7. A current sensing circuit according to claim 6, wherein the active load is a biased transistor a gate of which is biased by bias circuitry, said biased transistor being connected between the first transistor and a rail.

8. A current sensing circuit according to claim 1, wherein a second input of the comparator is amplified by the amplification stage.

9. A current sensing circuit according to claim 1, wherein each branch of the comparator current mirror comprises a comparator current mirror transistor, a gate of each of said comparator current mirror transistors being biased by bias circuitry.

10. A current sensing circuit according to claim 1, wherein the differential voltage comparator has a single output.

11. A current sensing circuit according to claim 1, wherein the differential voltage comparator comprises a comparator current mirror and has an output from each branch of said comparator current mirror.

12. A current sensing circuit according to claim 11, wherein the respective outputs of the differential voltage comparator are input to respective branches of a second current mirror.

13. A current sensing circuit according to claim 12, wherein an output of one branch of the second current mirror is output to a second amplification stage.

14. A current sensing circuit according to claim 13, wherein an output of the second amplification stage is connected to a third current mirror.

15. A current sensing circuit according to claim 14, wherein the third current mirror comprises at least two branches, each branch having a pair of transistors, a gate of a first one of each of said pair of transistors being connected to a gate of a transistor in the second amplification stage, and a gate of a second one of each of said pair of transistors being biased by bias circuitry.

16. A current sensing circuit according to claim 14, wherein an output of each branch of the third current mirror is connected to a push-pull circuit.

17. A current sensing circuit according to claim I 1, wherein an output of each branch of the comparator current mirror is connected to a push-pull circuit.

18. A current sensing circuit according to claim 13, wherein an output of each branch of the second current mirror is connected to a push-pull circuit.

19. A current sensing circuit according to claim 10, wherein the single output is connected to an amplifier.

20. A current sensing circuit according to claim 1, wherein the circuit is capable of sensing an analogue signal of 100 μA or less and outputting a rail-to-rail digital signal.
